(19) United States
(12) Patent Application Publication
(10) Pub. No.: US 2008/0125518 A1
(43) Pub. Date: May 29, 2008

(54) POLYESTER COMPOSITIONS WITH LOW GEL CONTENT AND METHOD OF MAKING THEM

(76) Inventors: Gaurav Mediratta, Bangalore (IN); Govind Subbanna Wagle, Bangalore (IN)

Correspondence Address: SABIC - O8CV - CPP;SABIC Innovative Plastics - IP Legal, ONE PLASTICS AVENUE, PITTSFIELD, MA, 01201-3697, US

(21) Appl. No.: 11/564,045

(22) Filed: Nov. 28, 2006

(51) Int. Cl. C08K 5/00; C08F 20/00

(52) U.S. Cl. 523/457; 523/400; 525/438

(57) ABSTRACT

A polyester resin composition comprising structural units derived from (i) a polyester having end groups and at least about 20 percent of acid end groups relative to a total number of the end groups;” and (ii) at least one bis epoxy compound having two epoxy groups, and wherein the bis epoxy compound does not have an ester or carbonate groups; and, wherein the polyester has a gel content in a range from about 0 to about 10 percent is disclosed. Also disclosed is a process to prepare these compositions and articles therefrom.

### BACKGROUND OF THE INVENTION

This invention relates to polyester compositions.

Thermoplastic polyesters are widely used as injection molded parts, fibers, bottles, films etc. The mechanical and physical properties of the polyesters are strongly dependent on their molecular weight. Further, the property requirements are different for each application. Therefore, resin manufacturers need to produce several polyester grades with different molecular weights for each application. However, it would be more economical to produce a single polyester resin with low molecular weight, which can then be “chain extended” to the desired molecular weight. Chain extension is a process for increasing molecular weight of polymers by reacting their end groups with multifunctional, usually bifunctional, compounds which “bridge” two chains thereby leading to an increase in the Degree of Polymerization.

Chain extension chemistry is also used in recycling of post consumer polyesters, e.g. polyethyleneterephthalate (PET). The recycling operations lead to a reduction in resin molecular weight, which then needs to be built back to make the resin usable for other applications. In the art, several chain extenders like epoxides, bisoxazolines, biscaprolactams, dianhydrides etc have been reported for use in polyesters. Among these, epoxides are most widely used on a commercial scale due to their relatively low cost and availability of a variety of structures.

It is desirable for chain extension process to be essentially free from branching and crosslinking. The branching and/or crosslinking lead to several undesired effects like increase in melt viscosity, loss in crystallinity and crystallization rate, inferior mechanical properties and also make the resin non-recyclable. Branching/crosslinking during chain extension happens due to reactions other than those between the polymer end group and the chain extender. This problem is particularly severe with epoxides.

U.S. Pat. No. 3,639,655 discloses a method for making polyesters with pendent hydroxyl groups, essentially free from crosslinking, by reacting diacids with bisepoxides using basic catalysts, preferably NaOH, in presence of a polar solvent. The presence of basic chemicals like organic bases and NaOH is known to reduce hydrolytic and thermal stability of polyesters. While U.S. Pat. No. 5,807,966 discloses a process for increasing molecular weight of polycondensates like polyamides, polyesters and polycarbonates, essentially without crosslinking, by using a diphosphonite in combination with a bifunctional compound like diepoxides, dianhydrides, bisoxazolines, bisoxazines, bisacyl lactams and diisocyanates. U.S. Pat. No. 6,028,129 teaches use of epoxides containing tetramethyl piperidine radical for chain extension and stabilization of polyamides, polyesters and polycarbonates and U.S. Pat. No. 6,417,243 suggests coatings with improved resistance to solvents, which can be prepared by cationic polymerization under irradiation.

Despite information such as that disclosed above, there remains a continuing unmet need for an epoxide chain extender that (i) can chain extend low molecular weight polyesters to high molecular weight polyesters while limiting branching and crosslinking to a minimum and (ii) does not interfere with the desirable properties of the polyester resin.

### BRIEF DESCRIPTION OF THE INVENTION

According to one embodiment of the present invention, the invention relates to a composition of matter comprising a polyester resin derived from:

i. a polyester having end groups and at least about 20 percent of acid end groups relative to a total number of the end groups;

ii. at least one bis epoxy compound having two epoxy groups, and wherein the bis epoxy compound does not have an ester or carbonate groups;

and wherein the polyester has a gel content ranging from 0 to about 10 weight percent.

In another embodiment, the invention relates to a process comprising

1. mixing a polyester and a bis epoxy compound to form a first mixture;

2. heating the first mixture at a temperature sufficiently high to form a composition of matter comprising a polyester resin derived from: a polyester having end groups and at least about 20 percent of acid end groups relative to a total number of the end groups; at least one bis epoxy compound having two epoxy groups, and wherein the bis epoxy compound does not have an ester or carbonate groups; and wherein the polyester has a gel content ranging from 0 to about 10 weight percent.

In another embodiment, the invention relates to an article molded from such a composition.

And in another embodiment, the invention relates to a composition of matter comprising a polyester resin derived from:

i. a polyester having end groups and at least about 20 percent of acid end groups relative to a total number of the end groups, wherein the polyester is derived from a diol selected from the group consisting of ethylene glycol; propylene glycol, butanediol, pentane diol; dipropylene glycol; 2-methyl-1,5-pentane diol; 1,6-hexane diol; dimethanol decalin, dimethanol bicyclo octane; cis-1,4-cyclohexane dimethanol, trans-1,4-cyclohexane dimethanol; triethylene glycol; 1,10-decane diol; tricyclodecane dimethanol; hydrogenated bisphenol-A, tetramethyl cyclobutane diol chemical equivalents of the foregoing, and combinations thereof, and a diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof;

ii. a bis epoxy compound comprising a compound having formula (II):

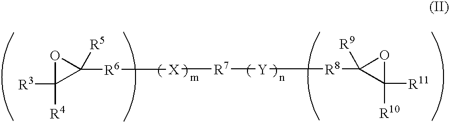

wherein R³, R⁵, R⁹ and R¹¹ are independently at each occurrence a hydrogen, a C₁-C₂₀ aliphatic, a C₃-C₂₀ cycloaliphatic or a C₃-C₂₀ aromatic radical, R⁴, R⁶, R⁸ and R¹⁰ are independently at each occurrence a C₁-C₂₀ aliphatic, a C₃-C₂₀ cycloaliphatic or a C₃-C₂₀ aromatic radical, and R⁴ and R⁶, R⁸ and R¹⁰, R⁴ and R¹⁰ are taken together to form part of a cyclic structure and R⁷ is a C₁-C₂₀ aliphatic, a C₃-C₂₀ cycloaliphatic or a C₃-C₂₀ aromatic radical, X and Y are a functional group other than an ester or a carbonate group and m and n are integers between 0 and 5; and

wherein the polyester has a gel content ranging from 0 to about 10 weight percent.

Various other features, aspects, and advantages of the present invention will become more apparent with reference to the following description, examples, and appended claims.

### DETAILED DESCRIPTION OF THE INVENTION

The invention is based on the discovery that certain bis epoxy compounds having substituents on both carbons of the epoxy rings, when used as chain extenders for polyesters, lead to a higher build-up in molecular weight while limiting crosslinking/branching. The invention is also based on the discovery that such epoxy compounds to be effective, need to be free from other polyester reactive groups such as an ester and a carbonate group.

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

“Combination” as used herein includes mixtures, copolymers, reaction products, blends, composites, and the like.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values and are inclusive of the minimum and maximum value. Unless expressly indicated otherwise, the various numerical ranges specified in this application are approximations.

As used herein the term “aliphatic radical” refers to a radical having a valence of at least one comprising a linear or branched array of atoms which is not cyclic. The array may include heteroatoms such as nitrogen, sulfur, silicon, selenium and oxygen or may be composed exclusively of carbon and hydrogen. Aliphatic radicals may be “substituted” or “unsubstituted”. A substituted aliphatic radical is defined as an aliphatic radical which comprises at least one substituent. A substituted aliphatic radical may comprise as many substituents as there are positions available on the aliphatic radical for substitution. Substituents which may be present on an aliphatic radical include but are not limited to halogen atoms such as fluorine, chlorine, bromine, and iodine. Substituted aliphatic radicals include trifluoromethyl, hexafluoroisopropylidene, chloromethyl; difluorovinylidene; trichloromethyl, bromoethyl, bromotrimethylene (e.g.—CH₂CHBrCH₂—), and the like. For convenience, the term “unsubstituted aliphatic radical” is defined herein to encompass, as part of the “linear or branched array of atoms which is not cyclic” comprising the unsubstituted aliphatic radical, a wide range of functional groups. Examples of unsubstituted aliphatic radicals include allyl, aminocarbonyl (i.e. —CONH₂), carbonyl, dicyanoisopropylidene (i.e. —CH₂C(CN)₂CH₂—), methyl (i.e. —CH₃), methylene (i.e. —CH₂—), ethyl, ethylene, formyl, hexyl, hexamethylene, hydroxymethyl (i.e. —CH₂OH), mercaptomethyl (i.e. —CH₂SH), methylthio (i.e. —SCH₃), methylthiomethyl (i.e. —CH₂SCH₃), methoxy, methoxycarbonyl, nitromethyl (i.e. —CH₂NO₂), thiocarbonyl, trimethylsilyl, t-butyldimethylsilyl, trimethyoxysilypropyl, vinyl, vinylidene, and the like. Aliphatic radicals are defined to comprise at least one carbon atom. A C₁-C₁₀ aliphatic radical includes substituted aliphatic radicals and unsubstituted aliphatic radicals containing at least one but no more than 10 carbon atoms.

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄⁻. Aromatic radicals may be “substituted” or “unsubstituted”. A substituted aromatic radical is defined as an aromatic radical which comprises at least one substituent. A substituted aromatic radical may comprise as many substituents as there are positions available on the aromatic radical for substitution. Substituents which may be present on an aromatic radical include, but are not limited to halogen atoms such as fluorine, chlorine, bromine, and iodine. Substituted aromatic radicals include trifluoromethylphenyl, hexafluoroisopropylidenebis(4-phenyloxy) (i.e. —OPhC(CF₃)₂PhO—), chloromethylphenyl; 3-trifluorovinyl-2-thienyl; 3-trichloromethylphenyl (i.e. 3-CCl₃Ph-), bromopropylphenyl (i.e. BrCH₂CH₂CH₂Ph-), and the like. For convenience, the term “unsubstituted aromatic radical” is defined herein to encompass, as part of the “array of atoms having a valence of at least one comprising at least one aromatic group”, a wide range of functional groups. Examples of unsubstituted aromatic radicals include 4-allyloxyphenoxy, aminophenyl (i.e. H₂NPh-), aminocarbonylphenyl (i.e. NH₂COPh-), 4-benzoylphenyl, dicyanoisopropylidenebis(4-phenyloxy) (i.e. —OPhC(CN)₂PhO—), 3methylphenyl, methylenebis(4-phenyloxy) (i.e. —OPhCH₂PhO—), ethylphenyl, phenylethenyl, 3-formyl-2-thienyl, 2-hexyl-5-furanyl; hexamethylene-1,6-bis(4-phenyloxy) (i.e. —OPh(CH₂)₆PhO—); 4-hydroxymethylphenyl (i.e. 4-HOCH₂Ph-), 4-mercaptomethylphemyl (i.e. 4-HSCH₂Ph-), 4-methylthiophenyl (i.e. 4-CH₃SPh-), methoxyphenyl, methoxycarbonylphenyloxy (e.g. methyl salicyl), nitromethylphenyl (i.e. -PhCH₂NO₂), trimethylsilylphenyl, t-butyldimethylsilylphenyl, vinylphenyl, vinylidenebis(phenyl), and the like. The term “a C₃-C₁₀ aromatic radical” includes substituted aromatic radicals and unsubstituted aromatic radicals containing at least three but no more than 10 carbon atoms. The aromatic radical 1-imidazolyl (C₃H₂N₂—) represents a C₃ aromatic radical. The benzyl radical (C₇H₈—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethy group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. Cycloaliphatic radicals may be “substituted” or “unsubstituted”. A substituted cycloaliphatic radical is defined as a cycloaliphatic radical which comprises at least one substituent. A substituted cycloaliphatic radical may comprise as many substituents as there are positions available on the cycloaliphatic radical for substitution. Substituents which may be present on a cycloaliphatic radical include but are not limited to halogen atoms such as fluorine, chlorine, bromine, and iodine. Substituted cycloaliphatic radicals include trifluoromethylcyclohexyl, hexafluoroisopropylidenebis(4-cyclohexyloxy) (i.e. —OC₆H₁₁C(CF₃)₂C₆H₁₁O—), chloromethylcyclohexyl; 3-trifluorovinyl-2-cyclopropyl; 3-trichloromethylcyclohexyl (i.e. 3-CCl₃C₆H₁₁—), bromopropylcyclohexyl (i.e. BrCH₂CH₂CH₂C₆H₁₁—), and the like. For convenience, the term “unsubstituted cycloaliphatic radical” is defined herein to encompass a wide range of functional groups. Examples of unsubstituted cycloaliphatic radicals include 4-allyloxycyclohexyl, aminocyclohexyl (i.e. H₂N C₆H₁₁—), aminocarbonylcyclopenyl (i.e. NH₂COC₅H₉—), 4-acetyloxycyclohexyl, dicyanoisopropylidenebis(4-cyclohexyloxy) (i.e. —OC₆H₁₁C(CN)₂C₆H₁₁O—), 3-methylcyclohexyl, methylenebis(4-cyclohexyloxy) (i.e. —OC₆H₁₁CH₂C₆H₁₁O—), ethylcyclobutyl, cyclopropylethenyl, 3-formyl-2-terahydrofuranyl, 2-hexyl-5-tetrahydrofuranyl; hexamethylene-1,6-bis(4-cyclohexyloxy) (i.e. —OC₆H₁₁(CH₂)₆ C₆H₁₁O—); 4-hydroxymethylcyclohexyl (i.e. 4-HOCH₂C₆H₁₁O—), 4-mercaptomethylcyclohexyl (i.e. 4-HSCH₂C₆H₁₁—), 4-methylthiocyclohexyl (i.e. 4-CH₃SC₆H₁₁—), 4-methoxycyclohexyl, 2-methoxycarbonylcyclohexyloxy (2-CH₃OCO C₆H₁₁O—), nitromethylcyclohexyl (i.e. NO₂CH₂C₆H₁₁O—), trimethylsilylcyclohexyl, t-butyldimethylsilylcyclopentyl, 4-trimethoxysilyethylcyclohexyl (e.g. (CH₃O)₃SiCH₂CH₂C₆H₁₁O—), vinylcyclohexenyl, vinylidenebis(cyclohexyl), and the like. The term “a C₃-C₁₀ cycloaliphatic radical” includes substituted cycloaliphatic radicals and unsubstituted cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H¹¹CH₂—) represents a C₇ cycloaliphatic radical.

According to one embodiment of the present invention, a polyester composition comprising (a) a linear polyester having greater than about 20 percent acid end groups relative to a total number of end groups; and (b) at least one bis epoxy compound not having an ester or a carbonate group, wherein the polyester has a get content in the range from about 0 to about 10 percent is disclosed.

Typically, such polyester resins include crystalline polyester resins such as polyester resins derived from an aliphatic or cycloaliphatic diol, or mixtures thereof, containing from 2 to about 10 carbon atoms and at least one aromatic dicarboxylic acid. Preferred polyesters are derived from an aliphatic diol and an aromatic dicarboxylic acid and have repeating units according to structural formula (I)

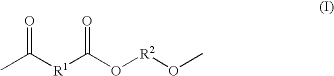

wherein, R1 and R2 are independently at each occurrence an aliphatic, an aromatic or a cycloaliphatic groups. In one embodiment, R2 is an alkyl radical compromising a dehydroxylated residue derived from an aliphatic or cycloaliphatic diol, or mixtures thereof, containing from 2 to about 20 carbon atoms and R1 is an aryl radical comprising a decarboxylated residue derived from an aromatic dicarboxylic acid. The polyester is a condensation product where R2 is the residue of an aryl, alkane or cycloalkane containing diol having 6 to 20 carbon atoms or chemical equivalent thereof, and R1 is the decarboxylated residue derived from an aryl, aliphatic or cycloalkane containing diacid of 6 to 20 carbon atoms or chemical equivalent thereof. The polyester resins are typically obtained through the condensation or ester interchange polymerization of a diol or diol equivalent component with a diacid or diacid chemical equivalent component.

The diacids meant to include carboxylic acids having two carboxyl groups each useful in the preparation of the polyester resins of the present invention are preferably aliphatic, aromatic, cycloaliphatic. Examples of diacids are cyclo or bicyclo aliphatic acids, for example, decahydro naphthalene dicarboxylic acids, norbornene dicarboxylic acids, bicyclo octane dicarboxylic acids, 1,4-cyclohexanedicarboxylic acid or chemical equivalents, and most preferred is trans-1,4-cyclohexanedicarboxylic acid or a chemical equivalent. Linear dicarboxylic acids like adipic acid, azelaic acid, dicarboxyl dodecanoic acid, and succinic acid may also be useful. Chemical equivalents of these diacids include esters, alkyl esters, e.g., dialkyl esters, diaryl esters, anhydrides, salts, acid chlorides, acid bromides, and the like. Examples of aromatic dicarboxylic acids from which the decarboxylated residue R¹ may be derived are acids that contain a single aromatic ring per molecule such as, e.g., isophthalic or terephthalic acid, 1,2-di(p-carboxyphenyl)ethane, 4,4′-dicarboxydiphenyl ether, 4,4′-bisbenzoic acid and mixtures thereof, as well as acids contain fused rings such as, e.g. 1,4-, 1,5-, or 2,6-naphthalene dicarboxylic acids. Preferred dicarboxylic acids include terephthalic acid, isophthalic acid, naphthalene dicarboxylic acids, and the like, and mixtures comprising at least one of the foregoing dicarboxylic acids.

Examples of the polyvalent carboxylic acid include, but are not limited to, an aromatic polyvalent carboxylic acid, an aromatic oxycarboxylic acid, an aliphatic dicarboxylic acid, and an alicyclic dicarboxylic acid, including terephthalic acid, isophthalic acid, ortho-phthalic acid, 1,5-naphthalenedicarboxylic acid, 2,6-naphthalenedicarboxylic acid, stilbenedicarboxylic acid, diphenic acid, sulfoterephthalic acid, 5-sulfoisophthalic acid, 4-sulfophthalic acid, 4-sulfonaphthalene 2,7-dicarboxylic acid, 5-[4-sulfophenoxy] isophthalic acid, sulfoterephthalic acid, p-oxybenzoic acid, p-(hydroxyethoxy)benzoic acid, succinic acid, adipic acid, azelaic acid, sebacic acid, dodecanedicarboxylic acid, fumaric acid, maleic acid, itaconic acid, hexahydrophthalic acid, tetrahydrophthalic acid, trimellitic acid, trimesic acid, and pyrromellitic acid. These may be used in the form of metal salts and ammonium salts and the like.

In one embodiment of the present invention, the diacids are selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

Some of the diols useful in the preparation of the polyester resins of the present invention are straight chain, branched, or cycloaliphatic alkane diols and may contain from 2 to 12 carbon atoms. Examples of such diols include but are not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and mixtures of any of the foregoing. In one embodiment the diol include glycols, such as ethylene glycol, propylene glycol, butanediol, hydroquinone, resorcinol, trimethylene glycol, 2-methyl-1,3-propane glycol, 1,4-butanediol, hexamethylene glycol, decamethylene glycol, 1,4-cyclohexane dimethanol, or neopentylene glycol. Chemical equivalents to the diols include esters, such as dialkylesters, diaryl esters, and the like. Examples of the polyvalent alcohol include, but are not limited to, an aliphatic polyvalent alcohol, an alicyclic polyvalent alcohol, and an aromatic polyvalent alcohol, including ethylene glycol, propylene glycol, 1,3-propanediol, 2,3-butanediol, 1,4-butanediol, 1,5-pentanediol, 1,6-hexanediol, neopentyl glycol, diethylene glycol, dipropylene glycol, 2,2,4-trimethyl-1,3-pentanediol, polyethylene glycol, polypropylene glycol, polytetramethylene glycol, trimethylolethane, trimethylolpropane, glycerin, pentaerythritol, 1,4-cyclohexanediol, 1,4-cyclohexanedimethanol, spiroglycol, tricyclodecanediol, tricyclodecanedimethanol, m-xylene glycol, o-xylene glycol, p-xylene glycol 1,4-phenylene glycol, bisphenol A, lactone polyester and polyols.

Further, with respect to the polyester resin obtained by polymerizing the polybasic carboxylic acids and the polyhydric alcohols either singly or in combination respectively, a resin obtained by capping the polar group in the end of the polymer chain using an ordinary compound capable of capping an end can also be used.

Suitable linear polyester resins include, e.g., poly(alkylene phthalate)s such as, e.g., poly(ethylene terephthalate) (“PET”), poly(butylene terephthalate) (“PBT”), poly(propylene terephthalate) (“PPT”), poly(cycloalkylene phthalate)s such as, e.g., poly(cyclohexanedimethanol terephthalate) (“PCT”), poly(alkylene naphthalate)s such as, e.g., poly(butylene-2,6-naphthalate) (“PBN”) and poly(ethylene-2,6-naphthalate) (“PEN”), poly(alkylene dicarboxylate)s such as, e.g., poly(butylene dicarboxylate).

Preferred polyesters are obtained by copolymerizing a glycol component and an acid component comprising at least about 70 mole %, preferably at least about 80 mole %, of terephthalic acid, or polyester-forming derivatives thereof. The preferred glycol, tetramethylene glycol, component can contain up to about 30 mole %, preferably up to about 20 mole % of another glycol, such as ethylene glycol, trimethylene glycol, 2-methyl-1,3-propane glycol, hexamethylene glycol, decamethylene glycol, cyclohexane dimethanol, neopentylene glycol, and the like, and mixtures comprising at least one of the foregoing glycols. The preferred acid component may contain up to about 30 mole %, preferably up to about 20 mole %, of another acid such as isophthalic acid, 2,6-naphthalene dicarboxylic acid, 2,7-naphthalene dicarboxylic acid, 1,5-naphthalene dicarboxylic acid, 4,4′-diphenyl dicarboxylic acid, 4,4′-diphenoxyethanedicarboxylic acid, sebacic acid, adipic acid, and the like, and polyester-forming derivatives thereof, and mixtures comprising at least one of the foregoing acids or acid derivatives.

Block copolyester resin components are also useful, and can be prepared by the transesterification of (a) straight or branched chain poly(alkylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. Especially useful when high melt strength is important are branched high melt viscosity resins, which include a small amount of, e.g., up to 5 mole percent based on the acid units of a branching component containing at least three ester forming groups. The branching component can be one that provides branching in the acid unit portion of the polyester, in the glycol unit portion, or it can be a hybrid branching agent that includes both acid and alcohol functionality. Illustrative of such branching components are tricarboxylic acids, such as trimesic acid, and lower alkyl esters thereof, and the like; tetracarboxylic acids, such as pyromellitic acid, and lower alkyl esters thereof, and the like; or preferably, polyols, and especially preferably, tetrols, such as pentaerythritol; triols, such as trimethylolpropane; dihydroxy carboxylic acids; and hydroxydicarboxylic acids and derivatives, such as dimethyl hydroxyterephthalate, and the like. Branched poly(alkylene terephthalate) resins and their preparation are described, for example, in U.S. Pat. No. 3,953,404 to Borman. In addition to terephthalic acid units, small amounts, e.g., from 0.5 to 15 mole percent of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexylenedimethanol, etc., as well as minor amounts of trifunctional, or higher, branching components, e.g., pentaerythritol, trimethyl trimesate, and the like

The polyesters in one embodiment of the present invention may be a polyether ester block copolymer consisting of a thermoplastic polyester as the hard segment and a polyalkylene glycol as the soft segment. It may also be a three-component copolymer obtained from at least one dicarboxylic acid selected from: aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid or 3-sulfoisophthalic acid, alicyclic dicarboxylic acids such as 1,4-cyclohexanedicarboxylic acid, aliphatic dicarboxylic acids such as succinic acid, oxalic acid, adipic acid, sebacic acid, dodecanedicarboxylic acid or dimeric acid, and ester-forming derivatives thereof, at least one diol selected from: aliphatic diols such as 1,4-butanediol, ethylene glycol, trimethylene glycol, tetramethylene glycol, pentamethylene glycol, hexamethylene glycol, neopentyl glycol or decamethylene glycol, alicyclic diols such as 1,1-cyclohexanedimethanol, 1,4-cyclohexanedimethanol or tricyclodecanedimethanol, and ester-forming derivatives thereof, and at least one poly(alkylene oxide) glycol selected from: polyethylene glycol or poly(1,2- and 1,3-propylene oxide) glycol with an average molecular weight of about 400-5000, ethylene oxide-propylene oxide copolymer, and ethylene oxide-tetrahydrofuran copolymer.

Typically, the polyester can have a number average molecular weight of about 5,000 atomic mass units (AMU) to about 200,000 AMU, as measured by gel permeation chromatography using polystyrene standards. Within this range, a number average molecular weight of at least about 8000 AMU is preferred. Also within this range, a number average molecular weight of up to about 100,000 AMU is preferred, and a number average molecular weight of up to about 50,000 AMU is more preferred.) It is contemplated that the polyesters have various known end groups. The end groups of the polyester are selected from the group consisting of acid end groups, hydroxyl end groups, vinyl end groups, ester end groups. In one embodiment of the present invention, the polyester has about 20 percent acid end groups relative to the total number of end groups. In another embodiment of the present invention, the polyester has from about 20 percent to about 100 percent acid end groups relative to the total number of end groups. The polyester can be present in the composition from about 10 to about 99 weight percent, based on the total weight of the composition. The preferred polyesters preferably have an intrinsic viscosity (as measured in 60:40 solvent mixture of phenol/tetrachloroethane at 25° C.) ranging from about 0.05 to about 1.5 deciliters per gram.

In one embodiment, the polyester composition comprises at least one bis epoxy compound not having an ester or a carbonate group. By bis epoxy compound is meant a compound having two terminal epoxy functionalities. Preferably the compound will contain only carbon, hydrogen and oxygen. Typically the bis epoxy compound not having an ester or a carbonate group comprises structural units derived from structure II

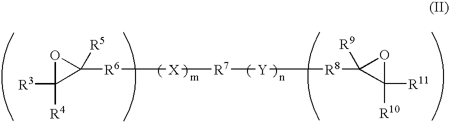

wherein R³, R⁵, R⁹ and R¹¹ are independently at each occurrence a hydrogen, a C₁-C₂₀ aliphatic, a C₃-C₂₀ cycloaliphatic or a C₃-C₂₀ aromatic radical, R⁴, R⁶, R⁸ and R¹⁰ are independently at each occurrence a C₁-C₂₀ aliphatic, a C₃-C₂₀ cycloaliphatic or a C₃-C₂₀ aromatic radical, and R⁴ and R⁶, R⁸ and R¹⁰, R⁴ and R¹⁰ are taken together to form part of a cyclic structure and R⁷ is a C₁-C₂₀ aliphatic, a C₃-C₂₀ cycloaliphatic or a C₃-C₂₀ aromatic radical, X and Y are a functional group other than an ester or a carbonate group and m and n are integers between 0 and 5.

Bis epoxy compound having structure II are exemplified in Table 1.

TABLE 1

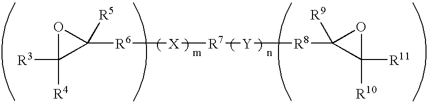

| Entry | R³ | R⁵ | R⁹ | R¹¹ | R⁴ | R⁶ | R⁷ | R⁸ | R¹⁰ | X | Y | m | n | Structure |
|---|---|---|---|---|---|---|---|---|---|---|---|---|---|---|
| I-1 | H | H | H | H | 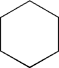 | | 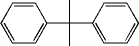 | 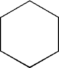 | | — | — | 0 | 0 | 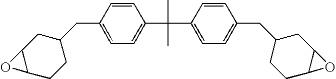 |
| I-2 | H | H | H | H | 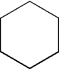 | | 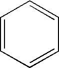 | 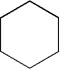 | | 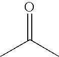 | 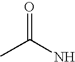 | 1 | 1 | 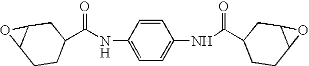 |
| I-3 | H | H | H | H | CH₃ | — | 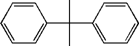 | — | CH₃ | O | O | 1 | 1 | 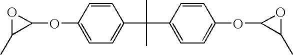 |

| | | | | | | | | | | |
|---|---|---|---|---|---|---|---|---|---|---|
| I-4 | H | H | H | H | 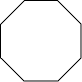 | — | — | 0 | 0 | 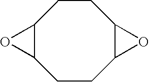 |

Some non-limiting examples of the bis epoxy compound are given in structures below

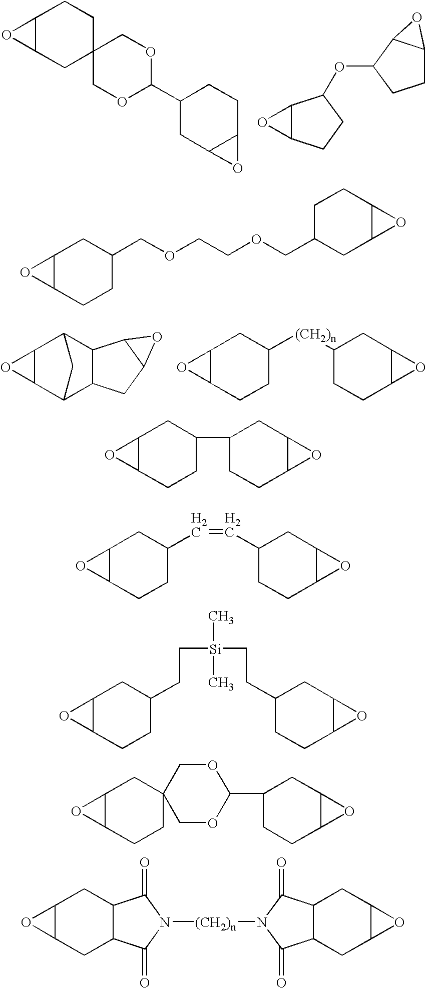

Epoxy functional materials suitable for use may contain aliphatic or cycloaliphatic epoxy functionalization. Generally, epoxy functional materials suitable for use herein are derived by the reaction of an epoxidizing agent, such as peracetic acid, and an aliphatic or cycloaliphatic point of unsaturation in a molecule. Other functionalities which will not interfere with an epoxidizing action of the epoxidizing agent may also be present in the molecule, for example, ethers, hydroxy, ketones, halogens, aromatic rings, etc. A well known class of epoxy functionalized materials are glycidyl ethers of aliphatic or cycloaliphatic alcohols or aromatic phenols. The alcohols or phenols may have more than one hydroxyl group.

The bis epoxide compounds can be made by techniques well known to those skilled in the art. For example, the corresponding .alpha, .beta.-dihydroxy compounds can be dehydrated to produce the epoxide groups, or the correspondingly unsaturated compounds can be epoxidized by treatment with a peracid, such as peracetic acid, in well-known techniques. The compounds are also commercially available.

The compound will preferably have a molecular weight of below about 1000. The bis epoxy compound have a boiling point greater than about 150° C., preferably in the range from about 150° C. to about 350° C. Preferred bis epoxy compounds will have at least one of the epoxide groups on a cyclohexane ring. Typically, the bis epoxy compound is present in a range from about 0.5 weight percent and about 35 weight percent based on the total weight of the composition. In another embodiment the bis epoxy compound is present in a range of from about 1.0 weight percent and about 15 weight percent based on the total weight of the composition.

In one embodiment of the present invention, the ratio of epoxy group of the bis epoxy compound to the amount of acid end group of the polyester is in a range from about 0.8 to about 1.2 mole percent.

In one embodiment, the composition of the present further include additives which do not interfere with the previously mentioned desirable properties but enhance other favorable properties such as anti-oxidants, flame retardants, flow modifiers, impact modifiers, colorants, mold release agents, UV light stabilizers, heat stabilizers, reinforcing materials, colorants, nucleating agents, lubricants, antidrip agents and combinations thereof. Additionally, additives such as antioxidants, minerals such as talc, clay, mica, and other stabilizers including but not limited to UV stabilizers, such as benzotriazole, supplemental reinforcing fillers such as flaked or milled glass, and the like, flame retardants, pigments or combinations thereof may be added to the compositions of the present invention. The additive is present ranging from about 0 to 40 weight percent, based on the total weight of the thermoplastic resin.

In yet another embodiment of the present invention, the composition further comprises a filler. The fillers may be of natural or synthetic, mineral or non-mineral origin, provided that the fillers have sufficient thermal resistance to maintain their solid physical structure at least at the processing temperature of the composition with which it is combined. Suitable fillers include clays, nanoclays, carbon black, wood flour either with or without oil, various forms of silica (precipitated or hydrated, fumed or pyrogenic, vitreous, fused or colloidal, including common sand), glass, metals, inorganic oxides (such as oxides of the metals in Periods 2, 3, 4, 5 and 6 of Groups Ib, IIb, IIIa, IIIb, IVa, IVb (except carbon), Va, VIa, VIIa and VIII of the Periodic Table), oxides of metals (such as aluminum oxide, titanium oxide, zirconium oxide, titanium dioxide, nanoscale titanium oxide, aluminum trihydrate, vanadium oxide, and magnesium oxide), hydroxides of aluminum or ammonium or magnesium, carbonates of alkali and alkaline earth metals (such as calcium carbonate, barium carbonate, and magnesium carbonate), antimony trioxide, calcium silicate, diatomaceous earth, fuller earth, kieselguhr, mica, talc, slate flour, volcanic ash, cotton flock, asbestos, kaolin, alkali and alkaline earth metal sulfates (such as sulfates of barium and calcium sulfate), titanium, zeolites, wollastonite, titanium boride, zinc borate, tungsten carbide, ferrites, molybdenum disulfide, asbestos, cristobalite, aluminosilicates including Vermiculite, Bentonite, montmorillonite, Na-montmorillonite, Ca-montmorillonite, hydrated sodium calcium aluminum magnesium silicate hydroxide, pyrophyllite, magnesium aluminum silicates, lithium aluminum silicates, zirconium silicates, and combinations comprising at least one of the foregoing fillers. Suitable fibrous fillers include glass fibers, basalt fibers, aramid fibers, carbon fibers, carbon nanofibers, carbon nanotubes, carbon buckyballs, ultra high molecular weight polyethylene fibers, melamine fibers, polyamide fibers, cellulose fiber, metal fibers, potassium titanate whiskers, and aluminum borate whiskers.

Alternatively, or in addition to a particulate filler, the filler may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

Optionally, the fillers may be surface modified. For example, the filler may be treated so as to improve the compatibility of the filler and the polymeric portions of the compositions, which facilitates deagglomeration and the uniform distribution of fillers into the polymers. One suitable surface modification is the durable attachment of a coupling agent that subsequently bonds to the polymers. Use of suitable coupling agents may also improve impact, tensile, flexural, and/or dielectric properties in plastics and elastomers; film integrity, substrate adhesion, weathering and service life in coatings; and application and tooling properties, substrate adhesion, cohesive strength, and service life in adhesives and sealants. Suitable coupling agents include silanes, titanates, zirconates, zircoaluminates, carboxylated polyolefins, chromates, chlorinated paraffins, organosilicon compounds, and reactive cellulosics. The fillers may also be partially or entirely coated with a layer of metallic material to facilitate conductivity, e.g., gold, copper, silver, and the like.

In a preferred embodiment, the reinforcing filler comprises glass fibers. For compositions ultimately employed for electrical uses, it is preferred to use fibrous glass fibers comprising lime-aluminum borosilicate glass that is relatively soda free, commonly known as “E” glass. However, other glasses are useful where electrical properties are not so important, e.g., the low soda glass commonly known as “C” glass. The glass fibers may be made by standard processes, such as by steam or air blowing, flame blowing and mechanical pulling. Preferred glass fibers for plastic reinforcement may be made by mechanical pulling. The diameter of the glass fibers is generally about 1 to about 50 micrometers, preferably about 1 to about 20 micrometers. Smaller diameter fibers are generally more expensive, and glass fibers having diameters of about 10 to about 20 micrometers presently offer a desirable balance of cost and performance. The glass fibers may be bundled into fibers and the fibers bundled in turn to yarns, ropes or rovings, or woven into mats, and the like, as is required by the particular end use of the composition. In preparing the molding compositions, it is convenient to use the filamentous glass in the form of chopped strands of about one-eighth to about 2 inches long, which usually results in filament lengths between about 0.0005 to about 0.25 inch in the molded compounds. Such glass fibers are normally supplied by the manufacturers with a surface treatment compatible with the polymer component of the composition, such as a siloxane, titanate, or polyurethane sizing, or the like.

When present in the composition, the filler may be used from about 0 to about 80 weight percent, based on the total weight of the composition. Within this range, it is preferred to use at least about 20 weight percent of the reinforcing filler. Also within this range, it is preferred to use up to about 70 weight percent, more preferably up to about 60 weight percent, of the reinforcing filler.

Flame-retardant additives are desirably present in an amount at least sufficient to reduce the flammability of the polyester resin, preferably to a UL94 V-0 rating. The amount will vary with the nature of the resin and with the efficiency of the additive. In general, however, the amount of additive will be from 1 to 30 percent by weight based on the weight of resin. A preferred range will be from about 5 to 20 percent.

Typically, halogenated aromatic flame-retardants include tetrabromobisphenol A polycarbonate oligomer, polybromophenyl ether, brominated polystyrene, , brominated imides, brominated polycarbonate, poly (haloaryl acrylate), poly (haloaryl methacrylate), or mixtures thereof. Examples of other suitable flame retardants are brominated polystyrenes such as polydibromostyrene and polytribromostyrene, decabromobiphenyl ethane, tetrabromobiphenyl, brominated alpha, omega-alkylene-bis-phthalimides, e.g. N,N′-ethylene-bis-tetrabromophthalimide, oligomeric brominated carbonates, especially carbonates derived from tetrabromobisphenol A, which, if desired, are end-capped with phenoxy radicals, or with brominated phenoxy radicals, or brominated epoxy resins.

The flame retardants are typically used with a synergist, particularly inorganic antimony compounds. Such compounds are widely available or can be made in known ways. Typical inorganic synergist compounds include Sb₂O₅, SbS₃, sodium antimonate and the like. Especially preferred is antimony trioxide (Sb₂O₃). Synergists such as antimony oxides, are typically used at about 0.1 to 10 by weight based on the weight percent of resin in the final composition. Also, the final composition may contain polytetrafluoroethylene (PTFE) type resins or copolymers used to reduce dripping in flame retardant thermoplastics. Also, other halogen-free flame retardants than the mentioned P or N containing compounds can be used, non limiting examples being compounds as Zn-borates, hydroxides or carbonates as Mg- and/or Al-hydroxides or carbonates, Si-based compounds like silanes or siloxanes, Sulfur based compounds as aryl sulphonates (including salts of it) or sulphoxides, Sn-compounds as stannates can be used as well often in combination with one or more of the other possible flame retardants.

Other additional ingredients may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl)propionic acid with mono- or polyhydric alcohols, e.g., with methanol, diethylene glycol, octadecanol, triethylene glycol, 1,6-hexanediol, pentaerythritol, neopentyl glycol, tris(hydroxyethyl)isocyanurate, thiodiethylene glycol, N,N-bis(hydroxyethyl)oxalic acid diamide. Typical, UV absorbers and light stabilizers include i) 2-(2′-hydroxyphenyl)-benzotriazoles, for example, the 5′methyl-,3′5′-di-tert-butyl-,5′-tert-butyl-,5′(1,1,3,3-tetramethylbutyl)-,5-chloro-3′,5′-di-tert-butyl-,5-chloro-3′tert-butyl-5′methyl-,3′sec-butyl-5′tert-butyl-,4′-octoxy,3′,5′-ditert-amyl-3′,5′-bis-(alpha, alpha-dimethylbenzyl)-derivatives; ii) 2.2 2-Hydroxy-benzophenones, for example, the 4-hydroxy-4-methoxy-,4-octoxy,4-decloxy-,4-dodecyloxy-,4-benzyloxy,4,2′,4′-trihydroxy- and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis-(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate.

The composition can further comprise one or more anti-dripping agents, which prevent or retard the resin from dripping while the resin is subjected to burning conditions. Specific examples of such agents include silicone oils, silica (which also serves as a reinforcing filler), asbestos, and fibrillating-type fluorine-containing polymers. Examples of fluorine-containing polymers include fluorinated polyolefins such as, for example, poly(tetrafluoroethylene), tetrafluoroethylene/hexafluoropropylene copolymers, tetrafluoroethylene/ethylene copolymers, polyvinylidene fluoride, poly(chlorotrifluoroethylene), and the like, and mixtures comprising at least one of the foregoing anti-dripping agents. A preferred anti-dripping agent is poly(tetrafluroethylene). When used, an anti-dripping agent is present in an amount of about 0.02 to about 2 weight percent, and more preferably from about 0.05 to about 1 weight percent, based on the total weight of the composition.

Dyes or pigments may be used to give a background coloration. Dyes are typically organic materials that are soluble in the resin matrix while pigments may be organic complexes or even inorganic compounds or complexes, which are typically insoluble in the resin matrix. These organic dyes and pigments include the following classes and examples: furnace carbon black, titanium oxide, zinc sulfide, phthalocyanine blues or greens, anthraquinone dyes, scarlet 3b Lake, azo compounds and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

In one embodiment of the present invention, the polyester resin composition has a molecular weight in the range from about 5000 to about 30000 as measured by gel permeation chromatography using polystyrene standards. In another embodiment, the polyester resin has a molecular weight greater than about 20000. The gel content of the polymer resin composition is in a range from about 0 to about 10 percent. In yet another embodiment, the gel content is in the range from about 0 to about 5 percent.

In one embodiment, the polyester composition may be made by conventional blending techniques. The production of the compositions may utilize any of the blending operations known for the blending of thermoplastics, for example blending in a kneading machine such as a Haake mixture, a Banbury mixer or an extruder. To prepare the composition, the components may be mixed by any known methods. Typically, there are two distinct mixing steps: a premixing step and a melt-mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device.

In one embodiment, the ingredients are pre-compounded, pelletized, and then molded. Pre-compounding can be carried out in conventional equipment. For example, after pre-drying the polyester composition (e.g., for about four hours at about 120° C.), a single screw extruder may be fed with a dry blend of the ingredients, the screw employed having a long transition section to ensure proper melting. Alternatively, a twin screw extruder with intermeshing co-rotating screws can be fed with resin and additives at the feed port and reinforcing additives (and other additives) may be fed downstream. The pre-compounded composition can be extruded and cut up into molding compounds such as conventional granules, pellets, and the like by standard techniques. The composition can then be molded in any equipment conventionally used for thermoplastic compositions, such as a Newbury type injection molding machine with conventional cylinder temperatures, at about 230° C. to about 280° C., and conventional mold temperatures at about 55° C. to about 95° C.

In one embodiment of the present invention, the polyesters are prepared by melt process. The process may be a continuous polymerization process wherein the said reaction is conducted in a continuous mode in a train of reactors of at least two in series or parallel. In an alternate embodiment the process may be a batch polymerization process wherein the reaction is conducted in a batch mode in a single vessel or in multiple vessels and the reaction can be conducted in two or more stages depending on the number of reactors and the process conditions. In an alternate embodiment, the process can be carried out in a semi-continuous polymerization process where the reaction is carried out in a batch mode and the additives are added continuously. Alternatively, the reaction is conducted in a continuous mode where the polymer formed is removed continuously and the reactants or additives are added in a batch process. In an alternate embodiment the product from at least one of the reactors can be recycled back into the same reactor intermittently by “pump around” to improve the mass transfer and kinetics of reaction. Alternatively the reactants and the additives are stirred in the reactors with a speed of about 25 revolutions per minute (here in after “rpm”) to about 2500 rpm. The composition of the invention may also be made by conventional composite making processes like pultrusion, vacuum bagging, compression molding etc.

In one embodiment of the present invention the process may be carried out in air or in an inert atmosphere. The inert atmosphere may be either nitrogen or argon or carbon dioxide. The heating of the various ingredients may be carried out in a temperature between about 150° C. and about 300° C. and at a pressure of about 0.01 to 1 atmosphere. In one embodiment the ingredients are heated to a temperature between 225° C. and about 250° C. and at a pressure of about 0.01 to 1 atmosphere to form the first mixture. In one embodiment the polyester is recovered by isolating the polymer followed by grinding or by extruding the hot polymer melt, cooling and pelletizing.

In one embodiment of the present invention, a catalyst may be employed. The catalyst may be an acidic, or basic or a transition metal based catalyst. The catalyst can be any of the catalysts commonly used in the prior art such as alkaline earth metal oxides such as magnesium oxides, calcium oxide, barium oxide and zinc oxide; alkali and alkaline earth metal salts; a Lewis catalyst such as tin or titananium compounds; a nitrogen-containing compound such as tetra-alkyl ammonium hydroxides used like the phosphonium analogues, e.g., tetra-alkyl phosphonium hydroxides or acetates. The Lewis acid catalysts and the aforementioned metal oxide or salts can be used simultaneously. In one embodiment the catalyst is not a tertiary amine or an alkali metal hydroxide.

The catalyst may be containing at least one selected from the group consisting of lithium salts, sodium salts, potassium salts, magnesium salts, calcium salts, zinc salts, and manganese salts of stearic acid and acetic acid. In one embodiment, the catalyst may be selected from the group consisting of alkali metal carboxylates, alkaline-earth metal carboxylates, aluminium, zinc, and manganese carboxylates. The metals contained in the metal carboxylates include alkali metals, such as lithium, sodium, and potassium; alkaline-earth metals, such as magnesium, calcium, strontium, and barium; and other metals, such as aluminium, zinc, and manganese. In one embodiment, the catalyst may be alkali metal halides, alkali metal carboxylates, alkali metal enolates, amine hydrohalides, alkali metal carbonates and quaternary ammonium halides. The carboxylic acid for forming salts together with those metals may be either of monocarboxylic acids, dicarboxylic acids and other polycarboxylic acids, and also may be polymer-like carboxylic acids. The number of carbon atoms of the carboxylic acid is not particularly limited. However, the number of carbon atoms of the carboxylic acid is 1 or more, which influences the rate of crystallization of the highly polymerized polyester obtained. In one embodiment the carboxylic acids of the carboxylates include aliphatic carboxylic acids having a carbon number in the range of 1 to 20, and particularly in the range of 1 to 10; alicyclic carboxylic acids having a carbon number in the range of 3 to 12; and aromatic carboxylic acids having a carbon number in the range of 7 to 20. Specifically, the carboxylic acids include acetic acid, propionic acid, butyric acid, caproic acid, adipic acid, stearic acid, palmitic acid, montanic acid, cyclohexanecarboxylic acid, benzoic acid, and phthalic acid.

In one embodiment, the catalyst may be lithium fluoride, lithium iodide, potassium bromide, potassium iodide, sodium dihydrogen phosphate, sodium acetate, sodium benzoate, sodium caproate, sodium stearate, sodium ascorbate and dodecyltrimethylammonium bromide and combinations thereof. In another embodiment the metal catalysts may be selected from the group consisting of aluminum, bismuth, calcium, cesium, cobalt, chromium, iron, magnesium, manganese, nickel, tin, organotin, titanium, zinc, zirconium compounds. While a wide variety of catalysts may be used, organic titanates such as tetrabutyl titanate may used alone or in so combination with magnesium or calcium acetates. In yet another embodiment, the catalyst may be complex titanates, such as derived from alkali or alkaline earth metal alkoxides and titanate esters, inorganic titanates, such as lanthanum titanate, calcium acetate/antimony trioxide mixtures and lithium and magnesium alkoxides.

Inorganic catalysts include compounds such as the hydroxides, hydrides, amides, carbonates, phosphates, borates, carboxylates etc., of alkali metals such as sodium, potassium, lithium, cesium, etc., and of alkali earth metals such as calcium, magnesium, barium, etc., can be cited such as examples of alkali or alkaline earth metal compounds. Typical examples include sodium stearate, sodium carbonate, sodium acetate, sodium bicarbonate, sodium benzoate, sodium caproate, or potassium oleate.

Co-catalyst may also be added to the mixture. In one embodiment, the co-catalyst may be at least one selected from the group consisting halides, carbonates or bicarbonates of alkali metals or alkaline earth metals, such as lithium chloride, potassium iodide or potassium carbonate; and alkali metal salts or alkaline earth metal salts, such as lithium salt, sodium salt, potassium salt, beryllium salt, magnesium salt, calcium salt, strontium salt or barium salt of aryl- or alkyl-substituted phosphines, such as tributyl phosphine, trioctyl phosphine or triphenyl phosphine, saturated fatty acids, such as butyric acid, valeric acid, caproic acid, lauric acid, myristic acid, palmitic acid, stearic acid, behenic acid or montanic acid, or unsaturated fatty acids, such as crotonic acid, oleic acid or elaidic acid.

In one embodiment, the catalyst is present in a range from about 0.01 to 1 5 by weight of total composition.

The reaction may be conducted optionally in presence of a solvent or in neat conditions without the solvent. The organic solvent used in the above process according to the invention should be capable of dissolving the polyester to an extent of at least 0.01 g/per ml at 25° C. and should have a boiling point in the range of 140-290° C. at atmospheric pressure. Preferred examples of the solvent include but are not limited to amide solvents, in particular, N-methyl-2-pyrrolidone; N-acetyl-2-pyrrolidone; N,N′-dimethyl formamide; N,N′-dimethyl acetamide; N,N′-diethyl acetamide; N,N′-dimethyl propionic acid amide; N,N′-diethyl propionic acid amide; tetramethyl urea; tetraethyl urea; hexamethylphosphor triamide; N-methyl caprolactam and the like. Other solvents may also be employed, for example, methylene chloride, chloroform, 1,2-dichloroethane, tetrahydrofuran, diethyl ether, dioxane, benzene, toluene, chlorobenzene, o-dichlorobenzene and the like.

The molten mixture of the polyester may be obtained in particulate form, e.g., by pelletizing or grinding the composition. The composition of the present invention can be molded into useful articles by a variety of means by many different processes to provide useful molded products such as injection, extrusion, rotation, foam molding calender molding and blow molding and thermoforming, compaction, melt spinning form articles. Non limiting examples of the various articles that could be made from the thermoplastic composition of the present invention include electrical connectors, electrical devices, computers, building and construction, outdoor equipment. The articles made from the composition of the present invention may be used widely in house ware objects such as food containers and bowls, home appliances, as well as films, electrical connectors, electrical devices, computers, building and construction, outdoor equipment, trucks and automobiles. In one embodiment the polyester may be blended with other conventional polymers.

The invention provides previously unavailable advantages. In on embodiment, for instance, the invention provides high molecular weight polyesters with limited branching and crosslinking while not interfering with the desirable properties of the polyester resin. In addition, the melting and crystallization temperatures are also high which is advantageous.

### EXAMPLES

Materials

Table 2 lists the different materials that were used in the Examples.

TABLE 2

| | Abbreviation | Source |
|---|---|---|
| Polybutyleneterephthalate (GPC | PBT | GE Plastics |
| Mn = 7500, Acid Number = | | |
| 393 meq/kg) | | |
| cis-1,2,3,6-tetrahydrophthalic | THPA | Aldrich |
| anhydride | | |
| Hexamethylene diamine, 98% | HMDA | Aldrich |
| N,N-dimethylformamide | DMF | Merck |
| Toluene | | Merck |
| Dichloromethane | DCM | Merck |
| m-chloro perbenzoic acid, 50–55% | MCPBA | Alfa Aesar |
| Methanol | | Merck |
| Sodium thiosulfate | | SD Finechem |
| Sodium Bicarbonate | | SD Finechem |
| Bisphenol A epoxy (Mn = 900) | AralditeGT6071 | Ciba |
| Cycloaliphatic epoxy | ERL4221 | Union Carbide |
| Diglycidylether of | DG-CHDM | Aldrich |
| cyclohexanedimethanol | | |
| 1,2,5,6-diepoxycyclooctane) | DECO | Aldrich |
| Sodium Stearate | NaSt | SD Finechem |

### Procedures/Techniques

Preparation of bis(4,5-epoxytetrahydrophthalimide)

In a Dean Stark separator 13.1 g cis-1,2,3,6-tetrahydrophthalic anhydride (THPA) and 5.0 g hexamethylene diamine (HMDA) were dissolved in a mixture of 100 mm N,N-dimethylforamide (DMF) and 40 ml toluene and the solution was heated under reflux conditions until no water was evolved. Toluene was removed from the above solution by distillation. The product bis(tetrahydrophthalimide), was separated from the solution by precipitation in methanol. The filtered product was then washed with methanol and dried in vacuum. The bis(tetrahydrophthalimide) was then epoxidized with m-chloroperbenzoic acid (MCPBA) under reflux conditions in dichloromethane. Typically 20 g of bis(tetrahydrophthalimide) and 17.9 g m-chloroperbenzoic acid (MCPBA) in 200 ml chloromethane (DCM) was heated under reflux for 6 hours. After the reaction was completed the MCPBA was allowed to precipitate overnight in a refrigerator and the clear solution was treated with 5%-sodium thiosulfate solution and further with a saturated solution of sodium bicarbonate in a separatory funnel, to eliminate respectively the peroxy acid and the acid. After drying over Magnesium sulfate, DCM was distilled off and bis(4,5-epoxytetrahydrophthalimide) was obtained as a white solid product. (Macromolecular Chemistry and Physics (1995), 196(4), 1051-61, incorporated herein by reference).

TABLE 3

| | | Boiling |
|---|---|---|
| | Bisepoxy | Point (° C.) |
| CEx.1 | 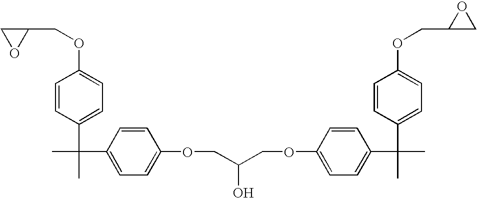 | >250 |
| CEx.2 | 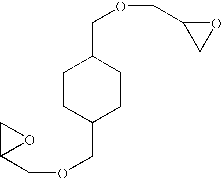 | >250 |
| CEx.3 | 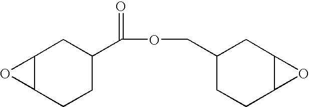 | >250 |
| CEx.4 | 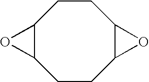 | 70 |
| Ex.1 | 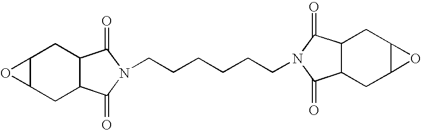 | >150 |

### Example 1 (Ex. 1) and Comparative Examples 1-4 (CEx.1-CEx.4)

In a Haake internal mixer PBT with a stoichiometric (with respect to acid number) amount of epoxy and 0.1 wt. % of sodium stearate were taken. Samples were withdrawn at 1, 5, 10 and 20 min. The samples were analyzed by Gel Permeation Chromatography (GPC) to determine the Mn. The insoluble fraction (Gel content) was determined in 5 weight % solution of trifluoroacetic acid in chloroform. Table 3 gives the bis epoxy compound employed in Ex.1 and CEx.1 to CEx.4.

TABLE 4

| | Time (min) | | | | | | | | | |
|---|---|---|---|---|---|---|---|---|---|---|
| | 1 | | 5 | | 10 | | 20 | | | |
| | | Gel | | Gel | | Gel | | Gel | Tₘ | T_{c} |
| | Mn(g/mol) | Content(%) | Mn(g/mol) | Content(%) | Mn(g/mol) | Content(%) | Mn(g/mol) | Content(%) | (° C.) | (° C.) |
| Ex. 1 | 8203 | 0 | 9883 | 0 | 10199 | 0 | 19536 | 0 | 186 | 131 |
| CEx. 1 | 8600 | 0 | 10045 | 8 | 12324 | 15 | 12965 | 38 | 165 | 110 |
| CEx. 2 | 8715 | 0 | 10625 | 4 | 11581 | 12 | 11975 | 29 | — | — |
| CEx. 3 | 8545 | 0 | 6786 | 0 | 7812 | 0 | 7326 | 0 | 216 | 176 |
| CEx. 4 | 8106 | 0 | 8128 | 0 | 8216 | 0 | 8195 | 0 | 219 | 182 |

### Results/Discussion

From Table 4 it can be observed that the Ex.1 gave more than 100% buildup in molecular weight (Mn) without any measurable Gel Content. While CEx.1 and CEx.2 gave a lower molecular weight build-up with around 30% gel content after 20 minutes. In the case of CEx.3 there was no gel formation, however only a marginal increase in molecular weight build up was observed. CEx.4 also does not lead to molecular weight build-up, which may be due to its low boiling point.

Differential Scanning Calorimetry (DSC) data i.e. the melting point (Tm) and Crystallization temperature (Tc) data for the 20-minute chain extended samples given in Table 4, show that CEx.3 and CEx.4 did not significantly effect the thermal properties which showed marginal chain extension with these epoxides. While CEx.1 showed minor peaks for melting and crystallization due to heavy crosslinking of the sample. Higher Tm and Tc have been observed for Ex.1 as compared to CEx.1.

The foregoing examples are merely illustrative, serving to illustrate only some of the features of the invention.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims.

1. A composition of matter comprising a polyester resin derived from:
i. a polyester having end groups and at least about 20 percent of acid end groups relative to a total number of the end groups;
ii. at least one bis epoxy compound having two epoxy groups, and wherein the bis epoxy compound does not have an ester or a carbonate group; and
wherein the polyester has a gel content ranging from 0 to about 10 weight percent.

2. The composition of claim 1, wherein the bis epoxy compound comprises a compound having formula (II): 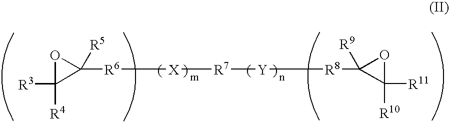
wherein R³, R⁵, R⁹ and R¹¹ are independently at each occurrence a hydrogen, a C₁-C₂₀ aliphatic, a C₃-C₂₀ cycloaliphatic or a C₃-C₂₀ aromatic radical, R⁴, R⁶, R⁸ and R¹⁰ are independently at each occurrence a C₁-C₂₀ aliphatic, a C₃-C₂₀ cycloaliphatic or a C₃-C₂₀ aromatic radical, and R⁴ and R⁶, R⁸ and R¹⁰, R⁴ and R¹⁰ are taken together to form part of a cyclic structure and R⁷ is a C₁-C₂₀ aliphatic, a C₃-C₂₀ cycloaliphatic or a C₃-C₂₀ aromatic radical, X and Y are a functional group other than an ester or a carbonate group and m and n are integers between 0 and 5.

3. The composition of claim 1, wherein the polyester is derived from a diacid selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof.

4. The composition of claim 1, wherein the polyester is derived from a diol selected from the group consisting of ethylene glycol; propylene glycol, butanediol, pentane diol; dipropylene glycol; 2-methyl-1,5-pentane diol; 1,6-hexane diol; dimethanol decalin, dimethanol bicyclo octane; cis-1,4-cyclohexane dimethanol, trans-1,4-cyclohexane dimethanol; triethylene glycol; 1,10-decane diol; tricyclodecane dimethanol; hydrogenated bisphenol-A, tetramethyl cyclobutane diol chemical equivalents of the foregoing, and combinations thereof

5. The composition of claim 1, wherein the polyester has an acid end groups ranging from about 20 percent to about 100 percent relative to the total number of end groups.

6. The composition of claim 1, wherein the bis epoxy compound has a boiling point of at least about 150° C.

7. The composition of claim 1, wherein the epoxy group and the acid group are at mole ratio in a range from about 0.8 to about 1.2.

8. The composition of claim 1, wherein the bis epoxy compound is present in an amount from about 0.5 weight percent to about 35 weight percent based on the total weight of the composition.

9. The composition of claim 1, wherein the composition further comprises an additive.

10. The composition of claim 9, wherein the additive is selected from the group consisting of anti-oxidants, flame retardants, flow modifiers, impact modifiers, colorants, mold release agents, UV light stabilizers, heat stabilizers, lubricants, antidrip agents and combinations thereof.

11. The composition of claim 9, wherein the additive is present ranging from about 0 to 40 weight percent, based on the total weight of the thermoplastic resin.

12. The composition of claim 1, wherein the composition further comprises a filler.

13. The composition of claim 12 wherein the filler is selected from the group consisting of calcium carbonate, mica, kaolin, talc, glass fibers, carbon fibers, carbon nanotubes, magnesium carbonate, sulfates of barium, calcium sulfate, titanium, nano clay, carbon black, silica, hydroxides of aluminum or ammonium or magnesium, zirconia, nanoscale titania, or a combination thereof.

14. The composition of claim 1, wherein the resin has a molecular weight in the range from about 5000 to about 50000.

15. An article molded from the composition of claim 1.

16. A process comprising:
1. mixing a polyester and a bis epoxy compound to form a first mixture;
2. heating the first mixture at a temperature sufficiently high to form a composition of matter comprising a polyester resin derived from:
i. a polyester having end groups and at least about 20 percent of acid end groups relative to a total number of the end groups;
ii. at least one bis epoxy compound having two epoxy groups, and wherein the bis epoxy compound does not have an ester or carbonate groups; and
wherein the polyester has a gel content ranging from 0 to about 10 weight percent.

17. The process of claim 16, wherein the first mixture is heated to a temperature ranging from about 150 to 280° C.

18. The process of claim 16, wherein the process is carried out in presence of a catalyst.

19. The process of claim 18, wherein the catalyst is selected from the group consisting of alkali metal and alkaline earth metal salts of aromatic dicarboxylic acids, alkali metal and alkaline earth metal salts of aliphatic dicarboxylic acids, Lewis acids, metal oxides, coordination complexes of the foregoing and combinations thereof.

20. The process of claim 18, wherein the catalyst is not a tertiary amine or an alkali metal hydroxide.

21. The process of claim 16, wherein the process is carried out in presence of a solvent.

22. The process of claim 16, wherein the process is carried out in presence of an inert atmosphere.

23. The process of claim 16, wherein the process is carried out in vacuum.

24. The process of claim 16, wherein the process is carried out at a pressure in the range from about 0.01 atmosphere to about 1 atmosphere.

25. A composition of matter comprising a polyester resin derived from:
i. a polyester having end groups and at least about 20 percent of acid end groups relative to a total number of the end groups; wherein the polyester is derived from a diol selected from the group consisting of ethylene glycol; propylene glycol, butanediol, pentane diol; dipropylene glycol; 2-methyl-1,5-pentane diol; 1,6-hexane diol; dimethanol decalin, dimethanol bicyclo octane; cis-1,4-cyclohexane dimethanol, trans-1,4-cyclohexane dimethanol; triethylene glycol; 1,10-decane diol; tricyclodecane dimethanol; hydrogenated bisphenol-A, tetramethyl cyclobutane diol chemical equivalents of the foregoing, and combinations thereof, and a diacid is selected from the group consisting of linear acids, terephthalic acids, isophthalic acids, phthalic acids, naphthalic acids, cycloaliphatic acids, bicyclo aliphatic acids, decahydro naphthalene dicarboxylic acids, norbornene dicarboxylic acids, bicyclo octane dicarboxylic acids, 1,4-cyclohexanedicarboxylic acid, adipic acid, azelaic acid, dicarboxyl dodecanoic acid, stilbene dicarboxylic acid, succinic acid, chemical equivalents of the foregoing, and combinations thereof;
ii. a bis epoxy compound comprising a compound having formula (II): 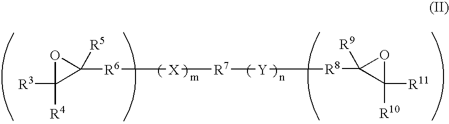
wherein R³, R⁵, R⁹ and R¹¹ are independently at each occurrence a hydrogen, a C₁-C₂₀ aliphatic, a C₃-C₂₀ cycloaliphatic or a C₃-C₂₀ aromatic radical, R⁴, R⁶, R⁸ and R¹⁰ are independently at each occurrence a C₁-C₂₀ aliphatic, a C₃-C₂₀ cycloaliphatic or a C₃-C₂₀ aromatic radical, and R⁴ and R⁶, R⁸ and R¹⁰, R⁴ and R¹⁰ are taken together to form part of a cyclic structure and R⁷ is a C₁-C₂₀ aliphatic, a C₃-C₂₀ cycloaliphatic or a C₃-C₂₀ aromatic radical, X and Y are a functional group other than an ester or a carbonate group and m and n are integers between 0 and 5;
wherein the polyester has a gel content ranging from 0 to about 10 weight percent.
